(19) United States
(12) Patent Application Publication
(10) Pub. No.: US 2008/0249842 A1
(43) Pub. Date: Oct. 9, 2008

(54) METHOD OF DETERMINING COST-PER-CLICK FOR KEYWORD ADVERTISEMENT

(75) Inventors: Joongoo Lee, Daejeon (KR); Ki Ho Song, Seoul (KR)

Correspondence Address: KNOBBE MARTENS OLSON & BEAR LLP, 2040 MAIN STREET, FOURTEENTH FLOOR, IRVINE, CA, 92614, US

(73) Assignee: NHN CORPORATION, Seongnam-si (KR)

(21) Appl. No.: 12/062,460

(22) Filed: Apr. 3, 2008

(30) Foreign Application Priority Data
Apr. 4, 2007 (KR) 10-2007-0033469

(51) Int. Cl. G06Q 10/00; G06Q 30/00

(52) U.S. Cl. 705/10; 705/14

(57) ABSTRACT

Disclosed is a method of computing a cost-per-click for a keyword advertisement. The method comprises receiving a plurality of submissions of proposed keyword advertisements for an identical keyword. Each submission comprises an advertisement content and a willing cost-per-click. The advertisement content of each submission or historical data is analyzed so as to generate a first index for each submission. A mathematical operation using the willing cost-per-click and the first index is performed so as to generate a second index for each submission. The second indexes of the submissions are ordered so as to generate rankings of the submissions. A cost-per-click for each submission is computed. A first computed cost-per-click for a first submission having a first rank is computed using the second index of a second submission having a second rank that is immediately next to the first rank.

### CROSS-REFERENCE TO RELATED APPLICATIONS

This application claims the benefit of Korean Patent Application No. 10-2007-0033469, filed on Apr. 4, 2007, in the Korean Intellectual Property Office, the disclosure of which is incorporated herein by reference in its entirety.

### BACKGROUND

1. Field

The present disclosure relates to a method of keyword advertisement, and more particularly, to determining cost-per-click for keyword advertisement.

2. Discussion of the Related Technology

In a cost per click (CPC, or cost-per-click) computing method, advertisers are required to input each bid amount suitable for a desired rank. Also, when a bid environment is changed due to new advertisement submission and an advertisement display rank is changed, advertisers are required to set a new bid amount for a desired rank. Advertisers are also required to monitor if the advertisement display rank is changed, and a revised bid amount is manually submitted for a desired advertisement display rank.

The discussion in this section is to provide general background information, and does not constitute an admission of prior art.

### SUMMARY

One aspect of the invention provides a method of computing a cost-per-click for a keyword advertisement, which comprises: receiving a plurality of submissions of proposed keyword advertisements for an identical keyword, each submission comprising an advertisement content and a willing cost-per-click; analyzing the advertisement content of each submission based on relevance of the advertisement content of the submission to the identical keyword, thereby generating a first index for each submission; performing a mathematical operation using the willing cost-per-click and the first index so as to generate a second index for each submission; ordering the second indexes of the plurality of submissions so as to generate rankings of the plurality of submissions, wherein each of the plurality of submissions for the identical keyword has a rank; and computing a cost-per-click for at least part of the plurality of submissions, wherein a first computed cost-per-click for a first submission having a first rank is computed using the second index of a second submission having a second rank that is immediately next to the first rank.

In the foregoing method, the advertisement content may comprise information that is to be displayed on a search result page in response to a search using the keyword. The advertisement content may comprise information contained in a webpage, an anchor tag of which is placed on a search result page in response to a search using the keyword. The willing cost-per-click may be an amount that an advertiser of a proposed keyword advertisement is willing to pay for a click-through of an anchor tag associated with the proposed keyword advertisement that is placed on a search result page in response to a search using the keyword. The first index may be a value indicative of the degree of relevance of the advertisement content of the submission to the keyword.

Still in the foregoing method, analyzing comprises counting the keyword and its derivative terms in the advertisement content, wherein the more the keyword and its derivative terms are, the higher the first index is. The mathematical operation may comprise at least one selected from the group consisting of a summation of the first index and the willing cost-per-click, a multiplication of one or more predetermined coefficients with at least one of the first index and the willing cost-per-click, a multiplication of the first index and the willing cost-per-click, a division of the first index by the willing cost-per-click, a division of the willing cost-per-click by the first index, a deduction of the first index from the willing cost-per-click, and deduction of the willing cost-per-click from the first index. The method may further comprise sending a first computed cost-per-click to a first advertiser of the first submission. The method may further comprise receiving an acceptance of the first computed cost-per-click from the first advertiser, conducting a keyword advertisement for the first advertiser, and charging to the first advertiser at the first computed cost-per-click.

Yet in the foregoing method, the first computed cost-per-click may be between the willing cost-per-click of the first submission and the willing cost-per-click of the second submission. The first computed cost-per-click is not greater than the willing cost-per-click of the first submission. The first computed cost-per-click may be greater than the willing cost-per-click of the second submission as a function of the willing cost-per-click of the second submission. The first rank may be immediately higher than the second rank. The keyword may comprise one or more word.

Further in the foregoing method, the method may further comprise providing historical data of clicking-throughs for at least part of the proposed keyword advertisements, and analyzing the historical data so as to modify the first index for the at least part of the proposed keyword advertisements. Each submission may further comprise a desired rank, wherein the method may further comprise determining whether the desired rank is higher or lower than the rank of the submission generated by ordering the second indexes, wherein if the desired rank is higher than the rank of the submission generated by ordering, the cost-per-click is not computed for the particular submission.

Another aspect of the invention provides a method of computing a cost-per-click for a keyword advertisement, which comprise: receiving a plurality of submissions of proposed keyword advertisements for an identical keyword, each submission comprising a willing cost-per-click and an address of a webpage that is to be displayed on a search result page in response to a search using the keyword; providing historical data of clicking-throughs for at least part of the proposed keyword advertisements that have been previously serviced; analyzing the historical data so as to generate a first index for the at least part of the proposed keyword advertisements; performing a mathematical operation using the willing cost-per-click and the first index so as to generate a second index for each submission; ordering the second indexes of the plurality of submissions so as to generate rankings of the plurality of submissions, wherein each of the plurality of submissions for the identical keyword has a rank; and computing a cost-per-click for one or more of the plurality of submissions, wherein the cost-per-click of a first one of the plurality of submissions having a first rank is computed using the second index of a second one of the plurality of submissions having a second rank that is immediately next to the first rank.

In the foregoing method, analyzing the historical data may comprise ranking the numbers of clicking-throughs for the at least part of the proposed keyword advertisements, wherein the first index is generated based on the ranking of the numbers. The greater the number is, the higher the first index is. The first index may be generated further based on the degree of relevance of the advertisement content of the submission to the keyword. The mathematical operation may comprise at least one selected from the group consisting of a summation of the first index and the willing cost-per-click, a multiplication of one or more predetermined coefficients with at least one of the first index and the willing cost-per-click, a multiplication of the first index and the willing cost-per-click, a division of the first index by the willing cost-per-click, a division of the willing cost-per-click by the first index, a deduction of the first index from the willing cost-per-click, and deduction of the willing cost-per-click from the first index.

Still in the foregoing method, the first computed cost-per-click may be between the willing cost-per-click of the first submission and the willing cost-per-click of the second submission. The first computed cost-per-click is not greater than the willing cost-per-click of the first submission. The first rank may be immediately higher than the second rank. Each submission may further comprise a desired rank, wherein the method may further comprise determining whether the desired rank is higher or lower than the rank of the submission generated by ordering the second indexes, wherein if the desired rank is higher than the rank of the submission generated by ordering, the cost-per-click is not computed for the particular submission.

An aspect of the present invention provides a method and system for automatically controlling a cost-per-click. Another aspect of the present invention also provides a method and system for automatically controlling a cost-per-click which determines an advertisement display rank and whether to display an advertisement using a desired advertisement display rank received by an advertiser, and thereby may guarantee the advertisement to be displayed to a rank equal to or higher than a rank desired by an advertiser, depending on an advertising bid situation.

Another aspect of the present invention also provides a method and system for automatically controlling a cost-per-click, which calculates a ranking index, which may be changed according to an advertising bid environment, using bid data received by an advertiser, and determines the bid amount based on the ranking index, thereby automatically controlling the cost-per-click.

Another aspect of the present invention also provides a method and system for automatically controlling a cost-per-click which uses a maximum cost per click and a quality index (QI) to calculate a maximum ranking index for determining a rank for each advertisement, and thereby enabling quality of an advertisement to be guaranteed.

Another aspect of the present invention also provides a method and system for automatically controlling a cost-per-click which determines a range of the cost-per-click based on a ranking index of a corresponding rank between a maximum ranking index of a corresponding advertisement and a maximum ranking index of a subsequent rank, and thereby enabling an advertiser to pay a more reasonable cost-per-click.

According to an embodiment of the present invention, there is provided a method of automatically controlling a cost-per-click, the method including: receiving a maximum CPC and a desired advertisement display rank from an advertiser; calculating a maximum ranking index for each advertisement using the maximum CPC; determining an advertisement display rank according to the maximum ranking index for each advertisement and the desired advertisement display rank; comparing a maximum ranking index of a corresponding rank and a maximum ranking index of a subsequent rank, and calculating a ranking index or an adjusted ranking index of a corresponding rank; and automatically controlling the cost-per-click based on the adjusted or calculated ranking index of the corresponding rank.

According to an aspect of the present invention, the determining of the advertisement display ranking includes: comparing the desired advertisement display rank and the advertisement display rank ordered according to the maximum ranking index for each advertisement, and excluding a corresponding advertisement from the advertisement display rankings according to an advertisement display on/off display command; and determining the advertisement display rank according to the maximum ranking index for each advertisement after excluding the corresponding advertisement from the advertisement display rank.

According to another aspect of the present invention, the ranking index of the corresponding rank is included in a range which is equal to or greater than the maximum ranking index of the subsequent rank and equal to or less than the maximum ranking index of the corresponding rank, and the comparing and calculating sums the maximum ranking index of the subsequent rank and a value obtained by multiplying a set or adjusting rate and a difference between the maximum ranking index of the corresponding rank and the maximum ranking index of the subsequent rank, to calculate the ranking index of the corresponding rank.

According to still another aspect of the present invention, the automatically controlling determines a value as the cost-per-click, the value being obtained by dividing the calculated ranking index of the corresponding rank into a quality index for each advertisement. Also, when the cost-per-click has an amount with a non-zero digit in a number's place which is less than a predetermined number's place, the amount is rounded up, and when the rounded-up cost-per-click is less than a reference amount, the reference amount is applied as the cost-per-click.

According to another aspect of the present invention, there is provided a system for automatically controlling a cost-per-click, the system including: a bid data input unit receiving a maximum CPC and a desired advertisement display rank from an advertiser; a maximum ranking index calculation unit calculating a maximum ranking index for each advertisement using the maximum CPC; an advertisement display rank determination unit determining an advertisement display rank according to the maximum ranking index for each advertisement and the desired advertisement display rank; a ranking index calculation unit comparing a maximum ranking index of a corresponding rank and a maximum ranking index of a subsequent rank, and calculating a ranking index of the corresponding rank; and a cost-per-click control unit automatically controlling the cost-per-click based on the calculated ranking index of the corresponding rank. A method of automatically controlling a cost-per-click according to an embodiment of the present invention may be performed by a system for automatically controlling a cost-per-click.

### BRIEF DESCRIPTION OF THE DRAWINGS

The above and/or other aspects and advantages of the present invention will become apparent and more readily appreciated from the following detailed description, taken in conjunction with the accompanying drawings of which:

FIG. 1 is a flowchart illustrating a method of automatically controlling a cost-per-click according to an embodiment of the present invention;

FIG. 2 is a flowchart illustrating an operation of determining an advertisement display rank according to an embodiment of the present invention;

FIG. 3 illustrates an example of receiving a maximum cost per click and a desired advertisement display rank from an advertiser according to an embodiment of the present invention;

FIG. 4 illustrates an example of determining an advertisement display rank according to a maximum ranking index for each advertisement according to an embodiment of the present invention;

FIG. 5 illustrates an example of controlling a cost-per-click based on a ranking index obtained from a maximum ranking index according to an embodiment of the present invention; and

FIG. 6 is a block diagram illustrating a system for automatically controlling a cost-per-click according to an embodiment of the present invention.

### DETAILED DESCRIPTION OF EMBODIMENTS

Reference will now be made in detail to embodiments of the present invention, examples of which are illustrated in the accompanying drawings, wherein like reference numerals refer to the like elements throughout.

When a rank is not changed after a new advertisement is bid on, advertisers may want a cost-per-click which is less than the bid amount. For example, when a bid amount of 150 is suggested to be the second rank and the third rank bidder offered a bid amount of 100, the second rank advertiser may desire to pay an amount between 100 and 150, not a full bid amount of 150, as a cost-per-click to maintain a current ranking. That is, when a bid amount is set to display an advertisement to a desired rank, the advertiser may need to pay an amount much greater than a minimum cost-per-click required to maintain a desired rank.

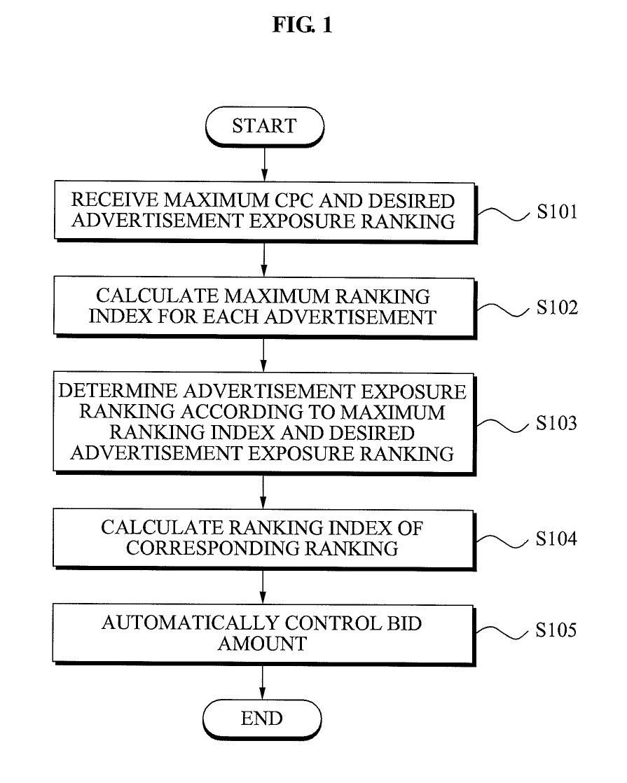

FIG. 1 is a flowchart illustrating a method of automatically controlling a cost-per-click according to an embodiment of the present invention.

In operation S101, a maximum cost per click or willing cost-per-click and a desired advertisement display rank are received from an advertiser. The maximum CPC is a maximum amount paid per click to display an advertisement to the desired advertisement display rank inputted by the advertiser. The willing cost-per-click is an amount that an advertiser of a proposed keyword advertisement is willing to pay for a click-through of an anchor tag associated with the proposed keyword advertisement that is placed on a search result page in response to a search using the keyword. In one embodiment, based on the maximum CPC of a subsequent rank and the difference between the maximum CPC of one advertiser and the maximum CPC of a subsequent rank, the cost-per-click of the advertiser can be adjusted.

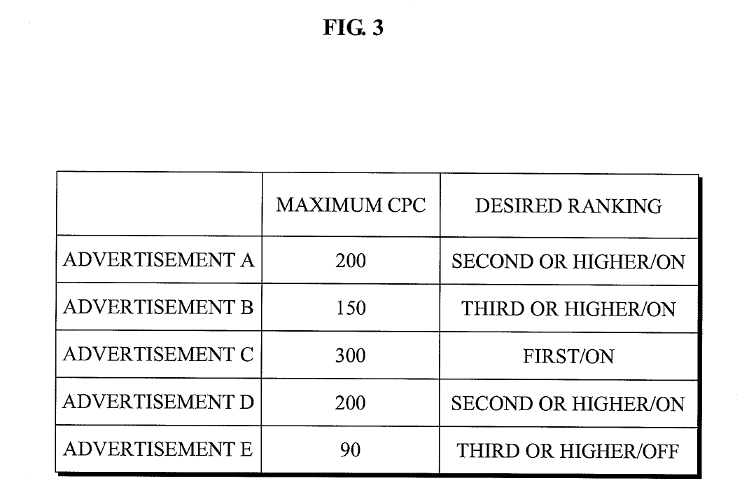

The desired advertisement display rank is any one of a desired ranking and desired ranking range of an advertisement the advertiser desires to expose. Also, the desired advertisement display rank may further include an advertisement display on/off display command according to the desired advertisement display rank. The maximum CPC and desired advertisement display rank are described in greater detail with reference to FIG. 3.

In operation S102, a maximum ranking index for each advertisement is calculated using the maximum CPC inputted by the advertiser. The maximum ranking index for each advertisement may be obtained by multiplying the maximum CPC and a quality index (QI) for each advertisement. In a CPC accounting method, when the QI for each advertisement is low even when the advertiser sets the maximum CPC high, the maximum ranking index may not be high. Accordingly, the advertiser may be required to improve the QI. The QI for each advertisement may be a numerical value of advertising evaluation factors associated with advertising quality, for example, a Click Through Rate (CTR) of the advertisement, degree of association between a search keyword and an advertising copy, degree of association between the search keyword and an advertising site, and the like.

In operation S103, an advertisement display rank is determined according to the maximum ranking index for each advertisement and the desired advertisement display rank.

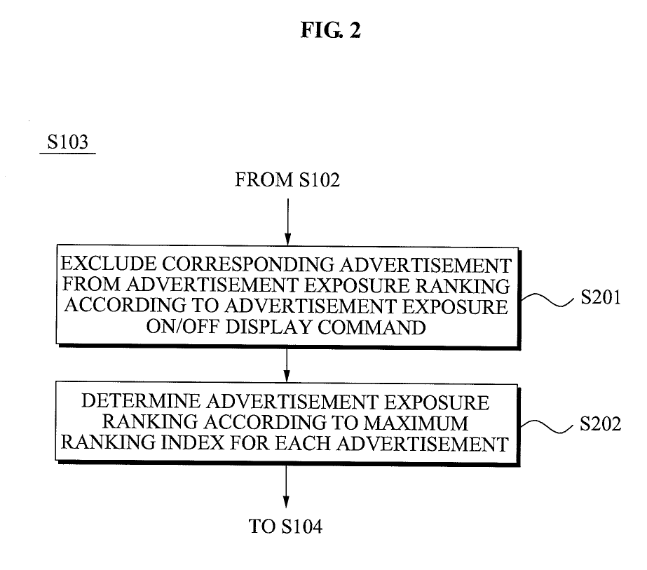

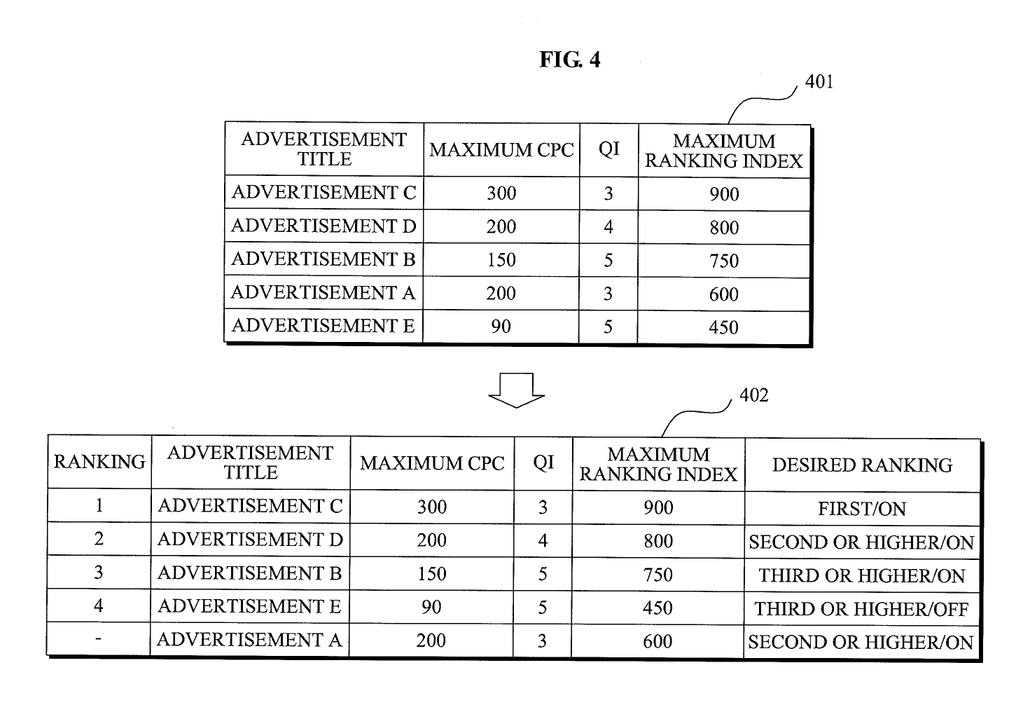

When determining the advertisement display rank using the maximum ranking index for each advertisement calculated in operation S102, whether to display the advertisement may be determined according to the desired advertisement display rank inputted by the advertiser. That is, the advertisement display rank is ordered according to the maximum ranking index for each advertisement, a desired advertisement display rank for each advertisement is compared, and thus it may be determined whether to include the advertisement in the advertisement display rank according to the advertisement display on/off display command. The desired ranking for each advertisement is inputted by the advertiser for each ranking. The determining of the advertisement display rank in operation S103 is described in greater detail with reference to FIGS. 2 and 4.

In operation S104, a maximum ranking index of a corresponding rank and a maximum ranking index of a subsequent rank are compared according to the advertisement display rank determined in operation S103, and a ranking index of the corresponding rank is calculated. The ranking index of the corresponding rank may be calculated in descending order of the determined advertisement display rank, although not limited thereto. In this instance, the ranking index of the corresponding rank may be calculated without considering a maximum ranking index of an advertisement excluded from the advertisement display ranking according to the advertisement display on/off display command.

The ranking index of the corresponding rank may be obtained by summing the maximum ranking index of the subsequent rank and a value. The value is obtained by multiplying a set rate and a difference between the maximum ranking index of the corresponding rank and the maximum ranking index of the subsequent rank. The set rate may be set, by the advertiser or the system for automatically controlling a cost-per-click, to be within a range of 0 to 100% of the difference between the maximum ranking index of the corresponding rank and the maximum ranking index of the subsequent rank. Also, the ranking index of the corresponding rank has a same value as the maximum ranking index of the corresponding rank when a rank is the lowest one of the advertisement display ranking.

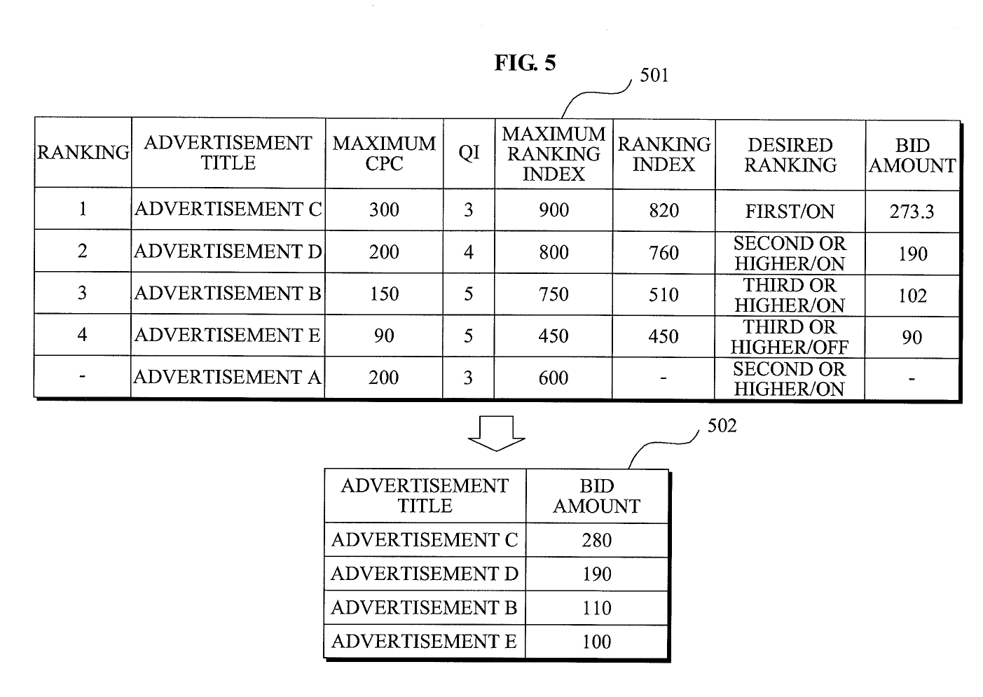

When the set rate is 0%, the ranking index of the corresponding rank is equal to the maximum ranking index of the subsequent rank. When the set rate is 100%, the ranking index of the corresponding rank is equal to the maximum ranking index of the corresponding rank. Accordingly, the set rate may be included in a range which is equal to or greater than the maximum ranking index of the subsequent rank and equal to or less than the maximum ranking index of the corresponding rank. An example of calculating the ranking index of the corresponding rank is described in greater detail with reference to FIG. 5.

In operation S105, the cost-per-click is automatically controlled based on the calculated ranking index of the corresponding rank calculated in operation S104. In this instance, the cost-per-click may be obtained by dividing the calculated ranking index of the corresponding rank into a QI for each advertisement. When the cost-per-click has an amount with a non-zero digit in a number's place which is less than a predetermined number's place, the amount is rounded up, and when the rounded-up cost-per-click is less than a reference amount, the reference amount is applied as the cost-per-click.

For example, when the cost-per-click is 113.6 Korean won and a non-zero digit in a number's place which is less than a one's place is rounded-up, the cost-per-click is controlled to be 120 Korean won. Also, when a reference amount is 130 Korean won, a final cost-per-click is 130 Korean won. For the above-calculation with respect to the cost-per-click, any one of rounding up, rounding off, and rounding down is used. An example of calculating the cost-per-click based on the ranking index of the corresponding rank is described in greater detail with reference to FIG. 5.

FIG. 2 is a flowchart illustrating an operation of determining an advertisement display rank according to an embodiment of the present invention.

An operation of determining the advertisement display rank in operation S103 is illustrated in FIG. 2. In brief, the advertisement display rank may be determined according to the maximum ranking index for each advertisement and the desired advertisement display rank.

In operation S201, to determine the advertisement display rank using the maximum ranking index for each advertisement, a corresponding advertisement may be excluded from the advertisement display ranking according to the advertisement display on/off display command inputted by the advertiser. The maximum ranking index for each advertisement is calculated in operation S102. The desired advertisement display rank and the advertisement display rank ordered according to the maximum ranking index for each advertisement are compared. When the ordered advertisement display rank is not included in the desired advertisement display rank or desired ranking range, whether to display the advertisement may be determined according to the advertisement display on/off display command.

For example, when the advertisement display rank is third and the advertiser inputs “second/on” or “second or higher/on” as the desired advertisement display rank condition, a corresponding advertisement may not be displayed and may be excluded from the advertisement display ranking, since the ordered advertisement display rank is not included in the desired advertisement display rank or desired ranking range and an advertisement display on display command is set. Although the advertisement display on/off display command may be interpreted differently from the above description, the advertisement display on display command indicates the advertisement is exposed, and an advertisement display off display command indicates the advertisement is excluded. That is, whether to display the advertisement may be determined depending on the desired advertisement display rank inputted by the advertiser and advertisement display on/off display command.

In operation S202, the advertisement display rank is determined according to the maximum ranking index for each advertisement, after excluding the corresponding advertisement using the desired advertisement display rank and advertisement display on/off display command. In this instance, rankings of advertisements in subsequent ranks of the corresponding advertisement, excluded from the advertisement display ranking ordered according to the maximum ranking index for each advertisement, may rise. The advertisement excluded from the advertisement display ranking may be listed on a ranking list according to the maximum ranking index for each advertisement, but may not be actually included in the advertisement display ranking. An example of the determining in operation S201 and operation S202 is described in detail with reference to FIG. 4.

FIG. 3 illustrates an example of receiving a maximum CPC and a desired advertisement display rank from an advertiser according to an embodiment of the present invention.

The maximum CPC is a maximum amount per click paid by the advertiser to display an advertisement. A difference between a maximum CPC of a subsequent rank and the maximum CPC is controllable to be within a range of 0 to 100% of the maximum CPC. For example, when a first advertiser's maximum CPC is 100, a second advertiser may input the second advertiser's maximum CPC from 100 to 200. When the difference between the maximum CPC of the subsequent rank and the maximum CPC exceeds a certain limit, a goal of advertising bid may not be achieved. Accordingly, a range of the difference is limited. The range may vary depending on a situation of system, popularity of advertisement, a number of advertisers that desire to bid, maximum CPC, and the like.

The desired advertisement display rank is a rank which is set to display the advertisement to a rank desired by the advertiser. A desired ranking range may refer to a range from a lowest display rank desired by the advertiser to a higher display rank than the lowest display rank. For example, when the advertiser desires to display the advertisement to a third position, the desired ranking range is to be specified as “third or higher”. Also, an advertisement display on/off display command may be used to determine whether to exclude the advertisement from the advertisement display ranking by comparing the desired advertisement display rank and the advertisement display rank ordered according to the maximum ranking index for each advertisement.

As illustrated in FIG. 3, an advertiser of an advertisement A and an advertiser of an advertiser D input 200 as a maximum CPC, and an advertiser of an advertisement C inputs 300 as a maximum CPC. As described above, the advertiser of the advertisement C may input 200 through 400 as the maximum CPC so that an advertisement with the maximum CPC of 200 is to be a subsequent rank. The maximum CPC of 200 through 400 is a range where 0 to 100% of the maximum CPC is added to the maximum CPC of 200. In FIG. 3, it is indicated that the advertisement A is displayed only when a rank ordered according to a maximum ranking index is second or higher. Also, it is indicated that the advertisement C is displayed only when the ranking ordered according to the maximum ranking index is first.

Also, it is indicated that an advertisement E is displayed only when the ranking ordered according to the maximum ranking index is fourth or lower. Specifically, the advertisement E is not displayed when the ranking ordered according to the maximum ranking index is third or higher. However, whether to display the advertisement may not be actually determined only based on data illustrated in FIG. 3, and may be determined according to the desired advertisement display rank and maximum ranking index for each advertisement. The desired advertisement display rank and maximum ranking index for each advertisement are calculated using the maximum CPC. Although the advertisement display on/off display command may be interpreted differently from the above description, an advertisement display on display command indicates the advertisement is exposed, and an advertisement display off display command indicates the advertisement is excluded.

FIG. 4 illustrates an example of determining an advertisement display rank according to a maximum ranking index for each advertisement according to an embodiment of the present invention.

In a table 401, the maximum ranking index is calculated by multiplying a QI of a corresponding advertisement and a maximum CPC inputted by an advertiser, and the calculated maximum CPC is ordered in descending order. A rank in the table 401 is not an actual advertisement display rank, and may be controlled according to a desired advertisement display rank. As illustrated in the table 401, even though the advertiser input a high maximum CPC, since the QI of the corresponding advertisement affects the maximum ranking index, the maximum ranking index may not be determined only based on the maximum CPC. Accordingly, to raise the maximum ranking index which affects an actual rank, setting the maximum CPC high or improving the QI may be required.

In a table 402, an actual advertisement display rank after determining whether to display the advertisements by considering the desired advertisement display rank and the advertisement display rank ordered based on the table 401 is illustrated. The desired advertisement display rank is inputted by the advertiser.

In principle, the actual advertisement display rank may be determined according to the maximum ranking index. The maximum ranking index is obtained by multiplying the QI of the advertisement and the maximum CPC inputted by the advertiser. Accordingly, the actual advertisement display rank is determined in an order of the advertisement C, advertisement D, advertisement B, advertisement A, and advertisement E which are ordered according to the maximum ranking index in the table 401. However, whether to display the advertisement may be determined according to the desired advertisement display rank inputted by the advertiser, and may be examined in descending order, respectively.

In the table 402, since a desired advertisement display rank of the advertisement C, that is, first-ranked advertisement, is “first/on”, the advertisement C is displayed and the actual advertisement display rank may be maintained. Also, a desired advertisement display rank of the advertisement D, that is, second-ranked advertisement, is “second or higher/on”, and a desired advertisement display rank of the advertisement B, that is, third-ranked advertisement, is “third or higher/on”, and thus the advertisement D and the advertisement B are displayed since each desired ranking range is satisfied. Also, the actual advertisement display rank may be maintained.

However, a desired advertisement display rank of the advertisement A, that is, fourth-ranked advertisement, is “second or higher/on”, and thus the advertisement A is not displayed since the desired ranking range is not satisfied. The advertisement A may be excluded from the actual advertisement display ranking. Also, although the advertisement E, that is, fifth-ranked advertisement, corresponds to a subsequent rank of the advertisement A, the advertisement E may raise to the fourth-ranked advertisement, since the advertisement A is excluded from the actual advertisement display ranking. In this instance, since a desired advertisement display rank of the advertisement E is “third or higher/off”, the fourth-rank is not included in the range of ‘third or higher’. Accordingly, the advertisement E is not excluded from the actual advertisement display ranking, and a rank of the advertisement E is fourth.

Thus, the advertisement C, advertisement D, advertisement B, and advertisement E are actually displayed in the order of the advertisement C, advertisement D, advertisement B, and advertisement E. Also, since the advertisement A is not exposed, an advertiser of the advertisement A is required to re-input the maximum CPC to display the advertisement A to a desired rank. When it is assumed that a new bid is added, the maximum ranking index is determined according to a bid amount, and thus an advertisement display rank may be automatically controlled according to the above-described operations.

FIG. 5 illustrates an example of controlling a cost-per-click based on a ranking index obtained from a maximum ranking index according to an embodiment of the present invention.

A table 501 illustrates the cost-per-click and a ranking index of a corresponding rank. The cost-per-click and the ranking index of the corresponding rank are obtained from a determined advertisement display rank and maximum ranking index for each advertisement. The maximum ranking index for each advertisement is calculated using a maximum CPC, and the cost-per-click is calculated based on the ranking index.

The ranking index of the corresponding rank may be determined by comparing a maximum ranking index of the corresponding rank and a maximum ranking index of a subsequent rank in descending order of the determined advertisement display rank. In this instance, a maximum ranking index of an advertisement excluded from the advertisement display ranking is not compared.

The ranking index of the corresponding rank may be determined by summing the maximum ranking index of the subsequent rank and a value. The value is obtained by multiplying a set rate and a difference between the maximum ranking index of the corresponding rank and the maximum ranking index of the subsequent rank. A method of determining the ranking index of the corresponding rank may be represented as,

RI(i)={MaxRI(i+1)+(MaxRI(i)−MaxRI(i+1))*x%} [Equation 1]

where RI(i) denotes the ranking index of the corresponding rank, Max RI(i) denotes the maximum ranking index of the corresponding rank, Max RI(i+1) denotes the maximum ranking index of the subsequent rank, and x % denotes the set rate. The set rate may be set, by an advertiser or the system for automatically controlling a cost-per-click, to be within a range of 0 to 100% of the difference between the maximum ranking index of the corresponding rank and the maximum ranking index of the subsequent rank. In FIG. 5, the set rate is 20%.

When Equation 1 is applied, a ranking index of an advertisement C, that is, first-ranked advertisement, may be determined by summing a maximum ranking index of an advertisement D, that is, second-ranked advertisement, and a value. The value is obtained by multiplying the set rate and a difference between a maximum ranking index of the advertisement C and the maximum ranking index of the advertisement D. Equation 1 is applied to Equation 2. The ranking index of the advertisement C may be represented as RI(1), which is calculated by,

$$\begin{matrix}R I ( 1 ) = \{ Max R I ( 2 ) + ( Max R I ( 1 ) - Max R I ( 2 ) * 20 \% \} \\ = \{ 800 + ( 900 - 800 ) * 20 \% \} \\ = 820\end{matrix} \qquad [ Equation 2 ]$$

A ranking index of the advertisement D and a ranking index of an advertisement B, that is, third-ranked advertisement, may be represented as RI(2) and RI(3), respectively. In the same way as the method of determining the ranking index of the corresponding rank, when Equation 1 is applied, the ranking index of the advertisement D and the ranking index of the advertisement B may be calculated by,

$$\begin{matrix}\begin{matrix}R I ( 2 ) = \{ Max R I ( 3 ) + ( Max R I ( 2 ) - Max R I ( 3 ) * 20 \% \} \\ = \{ 750 + ( 800 - 750 ) * 20 \% \} \\ = 760\end{matrix} & [ Equation 3 ] \\ \begin{matrix}R I ( 3 ) = \{ Max R I ( 4 ) + ( Max R I ( 3 ) - Max R I ( 4 ) * 20 \% \} \\ = \{ 450 + ( 750 - 450 ) * 20 \% \} \\ = 510\end{matrix} & [ Equation 4 ]\end{matrix}$$

Equation 1 may not be applied to an advertisement which is the lowest one of the advertisement display ranking, since a maximum ranking index of a subsequent rank of the advertisement does not exist. Accordingly, a ranking index of the lowest rank may be the same as the maximum ranking index of the corresponding advertisement. Thus, a ranking index of the advertisement E, that is, the lowest ranked-advertisement, may be 450 which is the same as the maximum ranking index of the advertisement E. Also, the ranking index of the advertisement E may be represented as RI(4).

The ranking index of the corresponding rank may be included in a range which is equal to or greater than the maximum ranking index of the subsequent rank, and equal to or less than the maximum ranking index of the corresponding rank. That is, as long as a new bid having an amount greater than the maximum ranking index of the corresponding rank is not suggested, an existing advertiser is required to pay a cost-per-click based on the ranking index within the range, in order to maintain a desired rank. Also, the existing advertiser is not required to pay a bid amount corresponding to the maximum ranking index of the corresponding rank, which is advantageous in terms of cost. Accordingly, the ranking index of the corresponding rank is a relative value, not an absolute value. When a new advertiser inputs a maximum CPC and desired advertisement display rank to bid, a maximum ranking index is calculated, and thus an existing advertisement display rank changes and ranking index may change.

In the example above, it may be assumed that an advertisement F is newly bid on. The advertisement F has a ranking index greater than the ranking index of the advertisement B and a maximum ranking index less than the maximum ranking index of the advertisement B. The maximum ranking index of the advertisement F is calculated using a maximum CPC of the advertisement F inputted by the advertiser. When the advertisement display rank is determined using the maximum ranking index without considering the desired advertisement display rank, the advertisement F corresponds to the ranking index of the advertisement B and advertisement E. Accordingly, the ranking index of each of the advertisement B and advertisement E automatically changes. In this instance, Equation 1 is applied. Thus, the ranking index may flexibly change according to a bid environment change and the cost-per-click is controlled.

Also, the advertiser may determine the cost-per-click based on the ranking index of the corresponding rank. Here, the cost-per-click may be determined by dividing the ranking index of the corresponding rank into a QI for each advertisement. A method of calculating the cost-per-click may be represented as,

$$\begin{matrix}BA ( i ) = R I ( i ) / Q I ( i ) \\ = \{ Max R I ( i + 1 ) + ( \begin{matrix}Max R I ( i ) - \\ Max R I ( i + 1 )\end{matrix} ) * x \% \} / Q I ( i )\end{matrix} \qquad [ Equation 5 ]$$

where BA(i) denotes a cost-per-click of the corresponding rank, QI(i) denotes a QI for each advertisement of the corresponding rank, RI(i) denotes a ranking index of the corresponding rank, Max RI(i) denotes a maximum ranking index of the corresponding rank, Max RI(i+1) denotes a maximum ranking index of the subsequent rank, and x % denotes the set rate.

Accordingly, the cost-per-click for each advertisement of the corresponding rank may be calculated by,

BA(1)=RI(1)/QI(1)=820/3=273.3

BA(2)=RI(2)/QI(2)=760/4=190

BA(3)=RI(3)/QI(3)=510/5=102

BA(4)=RI(4)/QI(4)=450/5=90 [Equation 6]

In this instance, when the cost-per-click has an amount with a non-zero digit in a number's place which is less than a predetermined number's place, the amount may be rounded up, and when the rounded-up cost-per-click is less than a reference amount, the reference amount is applied as the cost-per-click. In a table 502, a non-zero digit in a number's place which is less than a one's place is rounded-up. When the rounded-up cost-per-click is less than 100 which is the reference amount, 100 is applied as the cost-per-click. Accordingly, the cost-per-click for each advertisement is 280, 190, 110, and 100. When a new bid amount is suggested, the cost-per-click for each advertisement may be changed and the ranking index may also be changed, as described above.

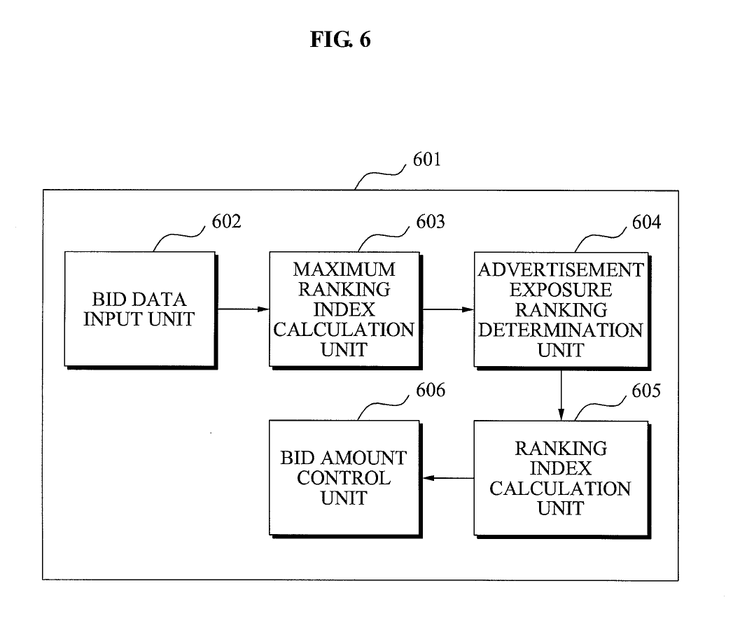

FIG. 6 is a block diagram illustrating a system 601 for automatically controlling a cost-per-click according to an embodiment of the present invention.

The system 601 for automatically controlling a cost-per-click may include a bid data input unit 602, a maximum ranking index calculation unit 603, an advertisement display rank determination unit 604, a ranking index calculation unit 605, and a cost-per-click control unit 606.

The bid data input unit 602 may receive a maximum CPC and a desired advertisement display rank from an advertiser. The maximum CPC and desired advertisement display rank are bid data.

The maximum ranking index calculation unit 603 may calculate a maximum ranking index for each advertisement by multiplying the maximum CPC received by the bid data input unit 602 and a QI of a corresponding advertisement.

The advertisement display rank determination unit 604 may determine an advertisement display rank according to the maximum ranking index for each advertisement and the desired advertisement display rank. The maximum ranking index for each advertisement is calculated by the maximum ranking index calculation unit 603. In this instance, the desired advertisement display rank and the advertisement display rank ordered according to the maximum ranking index for each advertisement are compared. Also, after excluding a corresponding advertisement from the advertisement display rank according to an advertisement display on/off display command, the advertisement display rank may be determined.

The ranking index calculation unit 605 may compare a maximum ranking index of a corresponding rank and a maximum ranking index of a subsequent rank, and calculate a ranking index of the corresponding rank. The ranking index of the corresponding rank may be calculated in descending order of the determined advertisement display rank. A maximum ranking index of an advertisement excluded from the advertisement display ranking according to an advertisement display on/off display command may be excluded when comparing.

A method of calculating a ranking index of the corresponding rank may be obtained by summing the maximum ranking index of the subsequent rank and a value. The value is obtained by multiplying a set rate and a difference between the maximum ranking index of the corresponding rank and the maximum ranking index of the subsequent rank. In this instance, the ranking index calculation unit 605 may apply a same value as the maximum ranking index of the corresponding rank when a rank is the lowest one of the advertisement display ranking.

The cost-per-click control unit 606 may automatically control the cost-per-click by dividing the calculated ranking index of the corresponding rank into a QI for each advertisement.

The method of automatically controlling a cost-per-click according to the above-described embodiment of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM disks and DVD; magneto-optical media such as optical disks; and hardware devices that are specially configured to store and perform program instructions, such as read-only memory (ROM), random access memory (RAM), flash memory, and the like. The media may also be a transmission medium such as optical or metallic lines, wave guides, and the like, including a carrier wave transmitting signals specifying the program instructions, data structures, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention.

According to an embodiment of the present invention, there is provided a method and system for automatically controlling a cost-per-click which sets a rank and automatically retrieves a cost-per-click for the rank when bidding.

Also, according to an embodiment of the present invention, there is provided a method and system for automatically controlling a cost-per-click which determines an advertisement display rank and whether to display an advertisement using a desired advertisement display rank received by an advertiser, and thereby may guarantee the advertisement to be displayed to a rank equal to or higher than a rank desired by an advertiser, depending on an advertising bid situation.

Also, according to an embodiment of the present invention, there is provided a method and system for automatically controlling a cost-per-click which calculates a ranking index, which may change according to an advertising bid environment, using bid data received by an advertiser, determines the cost-per-click based on the ranking index, and thereby may automatically control the cost-per-click.

Also, according to an embodiment of the present invention, there is provided a method and system for automatically controlling a cost-per-click which uses a maximum CPC and a QI to calculate a maximum ranking index for determining a rank for each advertisement, and thereby may enable quality of an advertisement to be guaranteed.

Also, according to an embodiment of the present invention, there is provided a method and system for automatically controlling a cost-per-click which determines a range of the cost-per-click based on a ranking index of a corresponding rank between a maximum ranking index of a corresponding advertisement and a maximum ranking index of a subsequent rank, and thereby may enable an advertiser to pay a more reasonable cost-per-click.

Although embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

What is claimed is:

1. A method of computing a cost-per-click for a keyword advertisement, the method comprising:
receiving a plurality of submissions of proposed keyword advertisements for an identical keyword, each submission comprising an advertisement content and a willing cost-per-click;
analyzing the advertisement content of each submission based on relevance of the advertisement content of the submission to the identical keyword, thereby generating a first index for each submission;
performing a mathematical operation using the willing cost-per-click and the first index so as to generate a second index for each submission;
ordering the second indexes of the plurality of submissions so as to generate rankings of the plurality of submissions, wherein each of the plurality of submissions for the identical keyword has a rank; and
computing a cost-per-click for at least part of the plurality of submissions, wherein a first computed cost-per-click for a first submission having a first rank is computed using the second index of a second submission having a second rank that is immediately next to the first rank.

2. The method of claim 1, wherein the advertisement content comprises information that is to be displayed on a search result page in response to a search using the keyword.

3. The method of claim 1, wherein the advertisement content comprises information contained in a webpage, an anchor tag of which is placed on a search result page in response to a search using the keyword.

4. The method of claim 1, wherein the first index is a value indicative of the degree of relevance of the advertisement content of the submission to the keyword.

5. The method of claim 1, wherein analyzing comprises counting the keyword and its derivative terms in the advertisement content, wherein the more the keyword and its derivative terms are, the higher the first index is.

6. The method of claim 1, wherein the mathematical operation comprises at least one selected from the group consisting of a summation of the first index and the willing cost-per-click, a multiplication of one or more predetermined coefficients with at least one of the first index and the willing cost-per-click, a multiplication of the first index and the willing cost-per-click, a division of the first index by the willing cost-per-click, a division of the willing cost-per-click by the first index, a deduction of the first index from the willing cost-per-click, and deduction of the willing cost-per-click from the first index.

7. The method of claim 1, further comprising sending a first computed cost-per-click to a first advertiser of the first submission.

8. The method of claim 7, further comprising:
receiving an acceptance of the first computed cost-per-click from the first advertiser;
conducting a keyword advertisement for the first advertiser; and
charging to the first advertiser at the first computed cost-per-click.

9. The method of claim 1, wherein the first computed cost-per-click is between the willing cost-per-click of the first submission and the willing cost-per-click of the second submission.

10. The method of claim 1, wherein the first computed cost-per-click is not greater than the willing cost-per-click of the first submission.

11. The method of claim 1, wherein the first computed cost-per-click is greater than the willing cost-per-click of the second submission as a function of the willing cost-per-click of the second submission.

12. The method of claim 1, wherein the first rank is immediately higher than the second rank.

13. The method of claim 1, wherein the keyword comprises one or more word.

14. The method of claim 1, further comprising:
providing historical data of clicking-throughs for at least part of the proposed keyword advertisements; and
analyzing the historical data so as to modify the first index for the at least part of the proposed keyword advertisements.

15. The method of claim 1, wherein each submission further comprises a desired rank, wherein the method further comprising:
determining whether the desired rank is higher or lower than the rank of the submission generated by ordering the second indexes, wherein if the desired rank is higher than the rank of the submission generated by ordering, the cost-per-click is not computed for the particular submission.

16. A method of computing a cost-per-click for a keyword advertisement, the method comprising:
receiving a plurality of submissions of proposed keyword advertisements for an identical keyword, each submission comprising a willing cost-per-click and an address of a webpage that is to be displayed on a search result page in response to a search using the keyword;
providing historical data of clicking-throughs for at least part of the proposed keyword advertisements that have been previously serviced;
analyzing the historical data so as to generate a first index for the at least part of the proposed keyword advertisements;
performing a mathematical operation using the willing cost-per-click and the first index so as to generate a second index for each submission;
ordering the second indexes of the plurality of submissions so as to generate rankings of the plurality of submissions, wherein each of the plurality of submissions for the identical keyword has a rank; and
computing a cost-per-click for one or more of the plurality of submissions, wherein the cost-per-click of a first one of the plurality of submissions having a first rank is computed using the second index of a second one of the plurality of submissions having a second rank that is immediately next to the first rank.

17. The method of claim 16, wherein analyzing the historical data comprises ranking the numbers of clicking-throughs for the at least part of the proposed keyword advertisements, wherein the first index is generated based on the ranking of the numbers.

18. The method of claim 17, wherein the greater the number is, the higher the first index is.

19. The method of claim 16, wherein the first index is generated further based on the degree of relevance of the advertisement content of the submission to the keyword.

20. The method of claim 16, wherein the mathematical operation comprises at least one selected from the group consisting of a summation of the first index and the willing cost-per-click, a multiplication of one or more predetermined coefficients with at least one of the first index and the willing cost-per-click, a multiplication of the first index and the willing cost-per-click, a division of the first index by the willing cost-per-click, a division of the willing cost-per-click by the first index, a deduction of the first index from the willing cost-per-click, and deduction of the willing cost-per-click from the first index.

21. The method of claim 16, wherein the first computed cost-per-click is between the willing cost-per-click of the first submission and the willing cost-per-click of the second submission.

22. The method of claim 16, wherein the first computed cost-per-click is not greater than the willing cost-per-click of the first submission.

23. The method of claim 16, wherein the first rank is immediately higher than the second rank.

24. The method of claim 16, wherein each submission further comprises a desired rank, wherein the method further comprising:
determining whether the desired rank is higher or lower than the rank of the submission generated by ordering the second indexes, wherein if the desired rank is higher than the rank of the submission generated by ordering, the cost-per-click is not computed for the particular submission.
